(19) United States
(12) Patent Application Publication
(10) Pub. No.: US 2005/0134286 A1
(43) Pub. Date: Jun. 23, 2005

(54) Systems and methods for defining acceptable device interconnect, and for evaluating device interconnect

(76) Inventor: Myron Joseph Schneider, Fort Collins, CO (US)

Correspondence Address: AGILENT TECHNOLOGIES, INC.;Legal Department, DL429, Intellectual Property Adminstration, P.O. Box 7599, Loveland, CO, 80537-0599, US

(21) Appl. No.: 10/741,555

(22) Filed: Dec. 19, 2003

(51) Int. Cl. G06F 19/00

(52) U.S. Cl. 324/537

(57) ABSTRACT

In a method for evaluating device interconnect, test data values corresponding to each of a number of interconnects of a device under test (DUT) are obtained. For a given interconnect of the DUT, one or more relationships between two or more of the test data values are evaluated to determine whether the given interconnect is acceptable. In a corresponding method for defining acceptable device interconnect, a plurality of known-good test data values are generated. The known-good test data values correspond to each of a number of interconnects for a device. For a given interconnect of the device, one or more relationships between two or more of the test data values are identified. A factor in identifying the relationships is a likelihood that one or more of the identified relationships will be impacted by the quality of the given interconnect. The relationships between test data values are quantified using the known-good test data values. The identified and quantified relationships are then used to define a function for evaluating the interconnect of a DUT.

### BACKGROUND

During manufacture, circuit assemblies (e.g., printed circuit boards and Multi-Chip Modules) need to be tested for interconnect defects such as open solder joints, broken connectors, and bent or misaligned leads (e.g., pins, balls, or spring contacts). One way to test for such defects is via capacitive lead-frame testing.

FIGS. 1 & 2 illustrate an exemplary setup for capacitive lead-frame testing (a form of vectorless test). FIG. 1 illustrates a circuit assembly 100 comprising an integrated circuit (IC) package 102 and a printed circuit board 104. Enclosed within the IC package is an IC 106. The IC is bonded to the leads 108, 110 of a lead-frame via a plurality of bond wires 112, 114. The leads, in turn, are meant to be soldered to conductive traces on the printed circuit board. Note, however, that one of the leads 108 is not soldered to the printed circuit board, thereby resulting in an “open” defect.

Positioned above the IC package 102 is a capacitive lead-frame test assembly 116. The exemplary test assembly 116 shown comprises a sense plate 118, a ground plane 120, and a buffer 122. The test assembly is coupled to an alternating current (AC) detector 124. A first, grounded test probe, TP_1, is coupled to lead 110 of the IC package. A second test probe, TP_2, is coupled to lead 108 of the IC package. The second test probe is also coupled to an AC source 126.

FIG. 2 illustrates an equivalent circuit for the apparatus shown in FIG. 1. In the equivalent circuit, C_{Sense} is the capacitance seen between the sense plate 118 and the lead 108 being sensed, and C_{Joint} is the capacitance seen between the lead 108 and the conductive trace (on the printed circuit board) to which the lead is supposed to be soldered. The switch, S, represents the quality of the lead being tested. If the lead being tested is good, switch S is closed, and the capacitance seen by the AC detector is C_{Sense}. If the lead being tested is bad, switch S is open, and the capacitance seen by the AC detector is C_{Sense}*C_{Joint}/(C_{Sense}+C_{Joint}). If C_{Sense} is significantly larger than C_{Joint}, an open lead will result in the AC detector seeing a capacitance near C_{Joint}. As a result, the AC detector must have sufficient resolution to distinguish C_{Sense} from Cⱼₒᵢₙₜ. If C_{Sense} is not significantly larger than C_{Joint}, the AC detector must have sufficient resolution to distinguish C_{Sense} from the series combination of C_{Sense} and Cⱼₒᵢₙₜ.

Additional and more detailed explanations of capacitive lead-frame testing are found in U.S. Pat. No. 5,557,209 of Crook et al. entitled “Identification of Pin-Open Faults by Capacitive Coupling Through the Integrated Circuit Package”, and in U.S. Pat. No. 5,498,964 of Kerschner entitled “Capacitive Electrode System for Detecting Open Solder Joints in Printed Circuit Assemblies”. One commercially available capacitive lead-frame test system is the TestJet system offered by Agilent Technologies, Inc. of Santa Rosa, Calif., USA. Another commercially available capacitive lead-frame test system is Vectorless Test EP (VTEP, which is also offered by Agilent Technologies, Inc.).

### SUMMARY

One aspect of the invention is embodied in a method for defining acceptable device interconnect. In accordance with the method, a plurality of known-good test data values corresponding to each of a number of interconnects for a device are generated. Then, for a given interconnect of the device, one or more relationships between two or more of the test data values are identified. A factor in identifying the relationships is a likelihood that one or more of the identified relationships will be impacted by the quality of the given interconnect. The relationships between test data values are quantified using the known-good test data values. The identified and quantified relationships are used to define a function for evaluating the interconnect of a device under test (DUT).

Another aspect of the invention is embodied in a method for evaluating device interconnect. In accordance with this second method, test data values corresponding to each of a number of interconnects of a DUT are obtained. Then, for a given interconnect of the DUT, one or more relationships between two or more of the test data values are evaluated to determine whether the given interconnect is acceptable.

A third aspect of the invention is embodied in a vectorless test system comprising computer readable media, and program code stored on the computer readable media. The program code comprises rules identifying i) which of a plurality of test data values are related to a test data value of a given device interconnect, and ii) relationships between the test data values. The program code further comprises code to receive a plurality of known-good test data values for a device and, in accordance with the rules, quantify the relationships between the test data values. The program code also comprises code to define a function for evaluating the interconnect of a DUT based on the identified and quantified relationships.

A fourth aspect of the invention is embodied in a second vectorless test system. The vectorless test system comprises a function approximator for generating a set of known-good test data values. The test system further comprises a relationship extractor for quantifying, for each interconnect of a device, a set of relationships between the known-good test data values. The test system also comprises a system for i) receiving the quantified relationships and acceptable and unacceptable noise limits, and ii) generating therefrom various patterns of acceptable and unacceptable relationships between test data values. A neural network of the test system has a training mode. When in its training mode, the neural network receives the various patterns and learns how to identify acceptable and unacceptable relationships between test data values of a DUT.

A final aspect of the invention is embodied in a third vectorless test system. The vectorless test system comprises computer readable media, and program code stored on the computer readable media. The program code comprises code to i) evaluate one or more relationships between two or more test data values, each value of which corresponds to an interconnect of a DUT, and ii) determine from the evaluation(s) whether a given interconnect of the DUT is acceptable.

Other embodiments of the invention are also disclosed.

### BRIEF DESCRIPTION OF THE DRAWINGS

Illustrative and presently preferred embodiments of the invention are illustrated in the drawings, in which:

FIGS. 1 & 2 illustrate an exemplary setup for capacitive lead-frame testing;

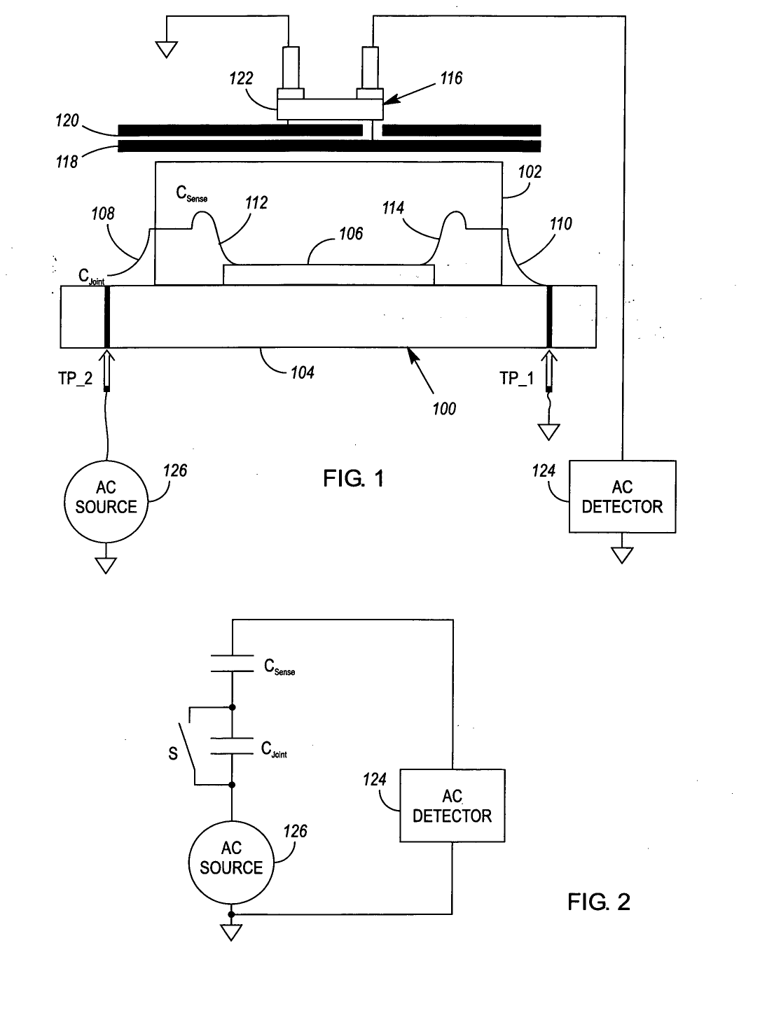

FIG. 3 shows some typical TestJet data for a square integrated circuit package having leads protruding from its sides;

FIG. 4 illustrates an exemplary method for defining acceptable device interconnect;

FIG. 5 illustrates a plurality of sets of known-good test data;

FIG. 6 illustrates a single, normalized set of test data values derived from the data in FIG. 5;

FIG. 7 illustrates an exemplary method for evaluating device interconnect; and

FIGS. 8-10 illustrate various embodiments of vectorless test systems.

### DESCRIPTION OF THE INVENTION

Although the embodiments of the invention described herein may be used in various applications, one application in which they may be used is vectorless test. More specifically, they may be used in capacitive lead-frame testing and, even more specifically, they may be used in TestJet testing.

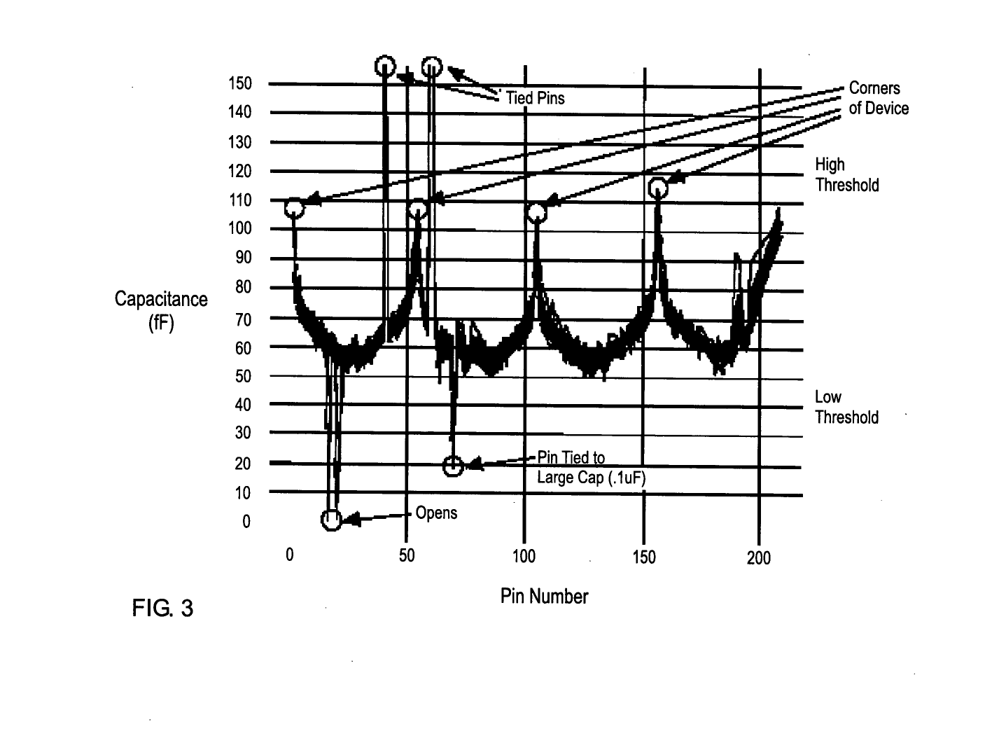

During the turn-on phase of a TestJet test system, a customer will visually examine the curves of several known-good boards (KGBs) before setting high and low thresholds that determine the difference between passing and failing boards in production. FIG. 3 shows some typical TestJet data for a square integrated circuit (IC) package having leads protruding from its sides. Traditional semiconductor packages typically have not required a customer to set thresholds on a pin-by-pin basis because their simplistic package geometries yielded obvious results when a pin was improperly connected. For the data shown in FIG. 3, a customer would probably set high and low failure thresholds of 120 femtoFarads (fF) and 40 fF, respectively. These thresholds are fairly loose given the apparent predictability of the data shown and could result in “test escapes”—where a poorly connected device is passed as good.

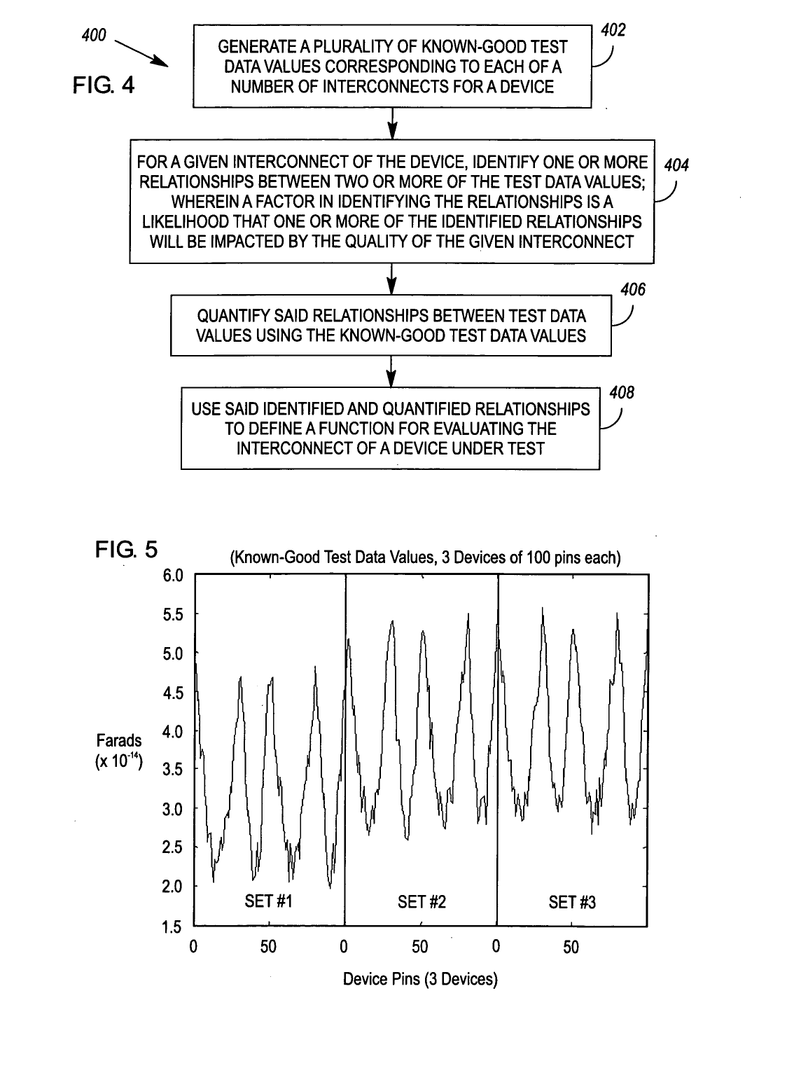

One way to reduce “test escapes” is to set individual failure thresholds on a pin-by-pin basis. However, the setting of pin-by-pin failure thresholds is a time consuming process that sometimes offers little better performance over the setting of global thresholds. FIGS. 4 & 7-10 therefore illustrate systems and methods for 1) defining acceptable device interconnect in terms of relationships between test data values, and 2) evaluating device interconnect based on relationships between test data values. By way of example, the test data values may be capacitances derived from TestJet tests, and the relationships between the test data values may be differences between the test data values.

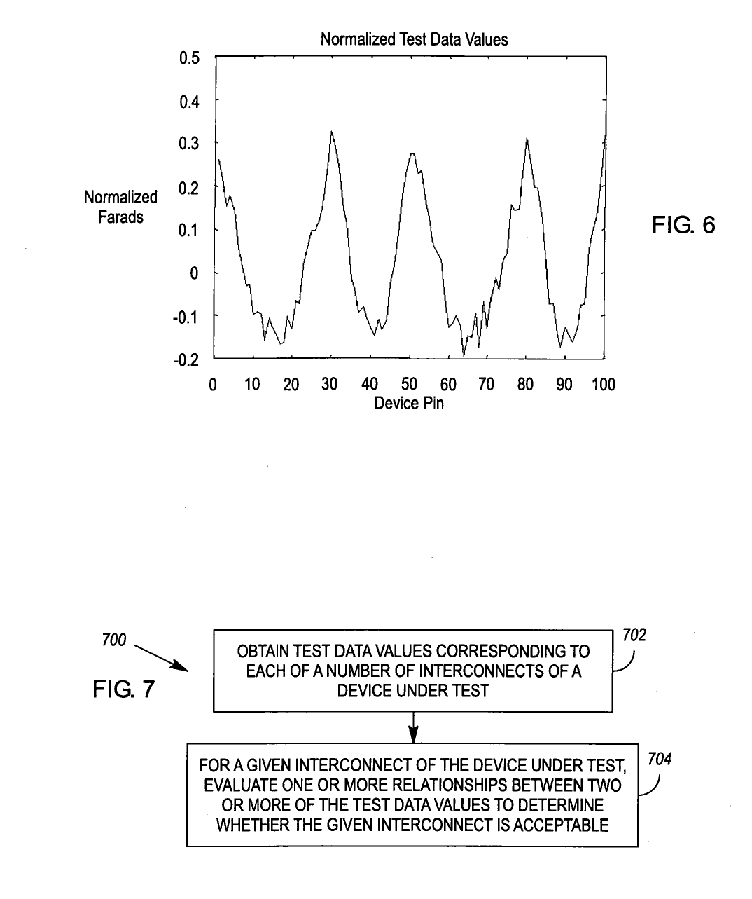

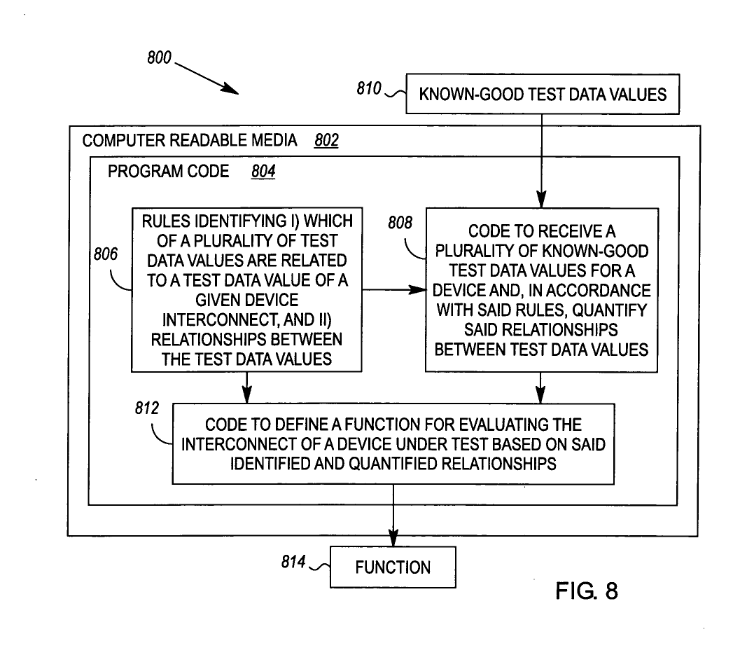

FIG. 4 illustrates a method 400 for defining acceptable device interconnect. The method 400 commences with the generation 402 of a plurality of known-good test data values corresponding to each of a number of interconnects for a device (e.g., leads of a device that are supposed to be soldered to a printed circuit board). In one embodiment of the method 400, the plurality of known-good test data values may be generated by first normalizing a plurality of sets of known-good test data values. The normalized sets of known-good test values may then be provided to a function approximator to generate a single, normalized set of known-good test data values. FIG. 5 illustrates a plurality of sets of known-good test data (SET #1, SET #2, SET #3), and FIG. 6 illustrates a single, normalized set of test data values derived from the data in FIG. 5. Plural sets of known-good test data values may be obtained from actual production tests, or from simulated production tests.

For a given interconnect of a device, one or more relationships between two or more of the test data values are identified 404. In one embodiment of the method 400, the relationships that are identified for a given interconnect comprise relationships between i) the test data value corresponding to the given interconnect, and ii) each of a number of test data values corresponding to one or more interconnects that are nearest the given interconnect. Thus, for an IC connected to a printed circuit board (PCB) via leads extending from its edges, relationships could be defined between i) a test data value corresponding to a given lead, and ii) the test data values corresponding to each of the two nearest neighbors on either side of the given lead (for a total of four relationships). In another embodiment of the method 400, the relationships that are identified for a given interconnect comprise relationships between i) the test data value corresponding to the given interconnect, and ii) each of a number of test data values corresponding to one or more interconnects that are within a defined window around the given interconnect. Thus, for an IC connected to a PCB via a ball grid array (BGA), relationships could be defined between i) a test data value for a given ball, and ii) the test data values corresponding to balls falling within a linear, round, square or other shaped window around the given ball. It should be noted that, in many cases, a windowing technique can easily be used to identify a given interconnect's nearest neighbors.

A factor in identifying test data relationships for a given interconnect should be the likelihood that one or more of the identified relationships will be impacted by the quality of the given interconnect. That is, if the given interconnect is unacceptable, at least one (and preferably all) of the identified relationships should deviate from its accepted range.

The method 400 continues as the identified relationships between test data values are quantified 406 using the known-good test data values. The identified and quantified relationships are then used to define 408 a function for evaluating the interconnect of a device under test (DUT).

In one embodiment of the method 400, defining a function for evaluating the interconnect of a DUT comprises training a neural network to recognize, for a given interconnect, patterns of acceptable relationships for the test data relationships that have been identified for the given interconnect. To illustrate this point, consider adjacent pins 1-5 of an arbitrary device. If a capacitance is measured after stimulating each of the five pins, the interconnect for pin 3 may be evaluated by identifying a relationship (e.g., a difference) between the capacitances of pins 3&1, pins 3&2, pins 3&4 and pins 3&5. If the difference relationships for these sets of pins are:
pins 3&1: −0.5
pins 3&2: −0.25
pins 3&4: 0.25
pins 3&5: 0.5
   then a pattern of acceptable relationships for pin 3 would be {−0.5, −0.25, 0.25, 0.5}. One way to train the neural network is to use the already quantified relationships to generate a first pattern of acceptable relationships (e.g., {−0.5, −0.25, 0.25, 0.5}), and then randomly generate a number of variants of the pattern by introducing acceptable noise into the pattern. The neural network may then be taught that each of the variants is a valid pattern of acceptable relationships.

In another embodiment of the method 400, defining a function for evaluating the interconnect of a DUT comprises training a neural network to recognize, for a given interconnect, patterns of acceptable and unacceptable relationships for the test data relationships that have been identified for the given interconnect. One way to do this is to use the already quantified relationships to generate a first pattern of acceptable relationships, and then randomly generate a number of variants of the pattern by introducing either acceptable or unacceptable noise into the pattern. The neural network may then be taught which of the variants are valid patterns and which of the variants are invalid patterns.

The limits of acceptable and unacceptable noise may be derived or estimated from various sources of information, including: information regarding the measurement uncertainty during acquisition of test data values, estimations of noise during acquisition of test data values, and manufacturing variations that are inherent in a DUT.

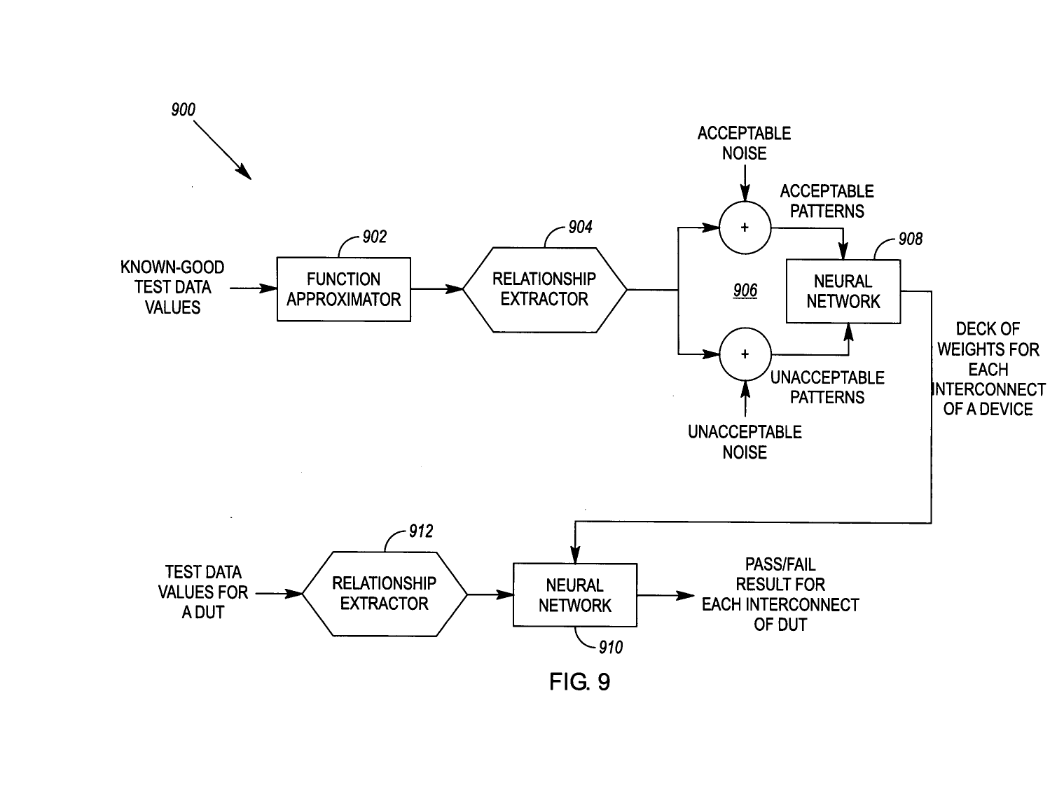

FIG. 7 illustrates a method 700 for evaluating device interconnect. In accordance with the method 700, test data values corresponding to each of a number of interconnects of a DUT are obtained 702. For a given interconnect of the DUT, one or more relationships between two or more of the test data values are evaluated 704 to determine whether the given interconnect is acceptable. In one embodiment of the method 700, a determination of whether a given interconnect is acceptable comprises a pass/fail indication.

In one embodiment of method 700, test data values are obtained by iteratively 1) stimulating at least one interconnect of the DUT, and 2) measuring an electrical characteristic between the stimulated interconnect(s) and a test sensor (e.g., a TestJet sensor).

The one or more relationships that are evaluated for a given interconnect may comprise relationships between i) the test data value corresponding to the given interconnect, and ii) each of a number of test data values corresponding to one or more interconnects that are nearest the given interconnect. Alternatively, the relationships may comprise relationships between i) the test data value corresponding to the given interconnect, and ii) each of a number of test data values corresponding to one or more interconnects that are within a defined window around the given interconnect. The relationships may also comprise other relationships.

Although a single relationship between two or more test data values may be evaluated by simply comparing it to an accepted range of values for the relationship, plural relationships for a given interconnect may be evaluated in a number of ways. For example, a plurality of relationships may be evaluated using matrix theory. Alternately (or additionally) relationships may be evaluated by submitting a pattern of the relationships to a neural network that has been trained to recognize patterns of acceptable relationships. A pattern of relationships may also be submitted to a neural network that has been trained to recognize patterns of both acceptable and unacceptable relationships. Any or all of said patterns of relationships may be defined to correspond to windows of adjacent interconnects of a DUT.

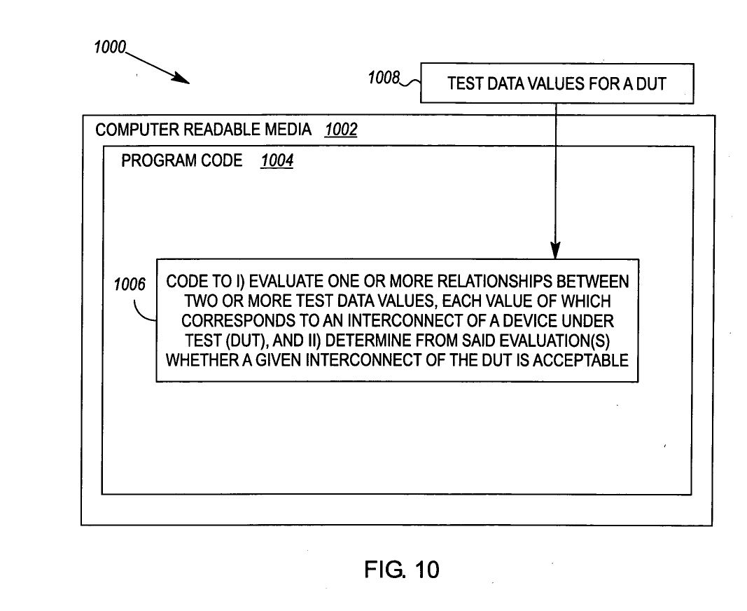

Turning now to FIG. 8, a vectorless test system 800 is shown. The system 800 comprises computer readable media 802, and program code 804 stored on the computer readable media 802. The program code 802 comprises rules 806 identifying i) which of a plurality of test data values are related to a test data value of a given device interconnect, and ii) relationships between the test data values. By way of example, the rules 806 may define relationships between i) the test data value corresponding to the given interconnect, and ii) the test data values corresponding to one or more interconnects that are nearest the given interconnect. The rules may also define relationships between i) the test data value corresponding to the given interconnect, and ii) the test data values corresponding to one or more interconnects that are within a defined window around the given interconnect.

The program code 804 of the system 800 further comprises code 808 to receive a plurality of known-good test data values 810 for a device and, in accordance with said rules, quantify said relationships between test data values. The program code 804 also comprises code 812 to define a function 814 for evaluating the interconnect of a device under test (DUT) based on said identified and quantified relationships. The function 814 defined by the code 812 may program a neural network to recognize, for a given interconnect, patterns of acceptable and unacceptable relationships for said identified relationships.

The program code of the system 800 may optionally comprise code to generate said plurality of known-good test data values. The code may generate these values by first normalizing a plurality of sets of known-good test data values, and then using a function approximator and the normalized sets of known-good test values to generate a single, normalized set of known-good test data values.

FIG. 9 illustrates a second vectorless test system 900. The system 900 comprises a function approximator 902 for generating a set of known-good test data values. In one embodiment, the function approximator i) normalizes a plurality of sets of known-good test data values, and then ii) consumes the normalized test data values to generate a single, normalized set of known-good test data values. The function approximator 902 may implement a variety of approximating techniques, including Widrow-Hopf performance learning, a least mean square analysis, or simple averaging. Sets of test data values may be identified as known-good by visually inspecting them. For example, with TestJet data the data forms recognizable curves, and departures from a “good” TestJet curve may be readily identified.

The output of the function approximator 902 is provided to a relationship extractor 904. The relationship extractor 904 quantifies, for each interconnect of a device, a set of relationships between said known-good test data values. By extracting relationships from a subset of test data values (i.e., a “window” of test data values) that are likely to be influenced by a given interconnect of a DUT, pattern matching migrates from a “global solution” to a “local solution”. Also, by migrating from a comparison of test data values to a comparison of test data relationships, arbitrary offsets in test data values as a result of a misplaced test sensor or the like are factored out of the analysis of whether device interconnects are acceptable.

By way of example, the set of relationships evaluated may be differences between test data values.

The output of the relationship extractor 904 is provided to a system 906 that receives said quantified relationships, as well as acceptable and unacceptable noise limits. In response to these inputs, the system 906 generates various patterns of acceptable and unacceptable relationships between test data values. The generated patterns are then input to a neural network 908 having a training mode so that the neural network learns how to identify acceptable and unacceptable relationships between test data values of a DUT. In essence, patterns of acceptable and unacceptable relationships between test data values may be “made up” based on known information such as: information regarding the measurement uncertainty during acquisition of test data values, estimations of noise during acquisition of test data values, and manufacturing variations that are inherent in a DUT.

The system 900 may further comprise a neural network 910 to i) consume patterns of test data corresponding to interconnects of a DUT, and ii) output indications of whether the consumed patterns are acceptable. Although the neural network 910 that performs these functions is separately referenced in FIG. 9, the two neural networks 908, 910 of the system 900 may be embodied in a single neural network that is switchable between a training mode and a test mode.

The system 900 may further comprise a relationship extractor 912 for quantifying relationships between the test data values of a DUT.

FIG. 10 illustrates a third vectorless test system 1000. The system 1000 comprises computer readable media 1002, and program code 1004 stored on the computer readable media 1002. The program code 1004 comprises code 1006 to i) evaluate one or more relationships between two or more test data values, each value of which corresponds to an interconnect of a device under test (DUT), and ii) determine from said evaluation whether a given interconnect of the DUT is acceptable. The program code 1004 may define a neural network that receives said relationships and outputs a pass/fail indication for said given interconnect.

By way of example, the one or more relationships evaluated by the system 1000 may comprise relationships between i) the test data value corresponding to the given interconnect, and ii) the test data values corresponding to one or more interconnects that are nearest the given interconnect. The evaluated relationships may also comprise relationships between i) the test data value corresponding to the given interconnect, and ii) the test data values corresponding to one or more interconnects that are within a defined window around the given interconnect.

The neural networks disclosed herein may be variously implemented. In one embodiment, they are three-layer backpropagation networks. The number of neurons in the first and second layers may be modified for system performance, while the output layer may consist of two neurons, one each for acceptable and unacceptable classifications (or one each for pass and fail). To minimize training speed, the backpropagation networks may utilize momentum.

It was discovered through preliminary experimentation that the accuracy of the above systems and methods were acceptable when only three known-good sets of test data values were provided to a Widrow-Hopf function approximator that was trained 10,000 epochs before stopping training because the mean squared error was at an acceptable value. However, more or less known-good sets of test data values also provided acceptable results. It was also discovered that increasing the number of “training patterns” for a neural network (i.e., the number of patterns incorporating random acceptable and unacceptable noise) from 10 to 20 to 30 to 40 provided significant increases in the percentage of device interconnects that were correctly classified by the systems and methods. The error goal and number of hidden neurons used by the neural networks provided slight variations in the percentage of device interconnects that were correctly classified, but less so than the number of training patterns provided to a neural network.

While illustrative and presently preferred embodiments of the invention have been described in detail herein, it is to be understood that the inventive concepts may be otherwise variously embodied and employed, and that the appended claims are intended to be construed to include such variations, except as limited by the prior art.

1. A method for defining acceptable device interconnect, comprising:
generating a plurality of known-good test data values corresponding to each of a number of interconnects for a device;
for a given interconnect of the device, identifying one or more relationships between two or more of the test data values; wherein a factor in identifying the relationships is a likelihood that one or more of the identified relationships will be impacted by the quality of the given interconnect;
quantifying said relationships between test data values using the known-good test data values; and
using said identified and quantified relationships to define a function for evaluating the interconnect of a device under test (DUT).

2. The method of claim 1, wherein generating a plurality of known-good test data values comprises:
normalizing a plurality of sets of known-good test data values; and
using a function approximator and the normalized sets of known-good test values to generate a single, normalized set of known-good test data values.

3. The method of claim 1, wherein said test data values are capacitances.

4. The method of claim 1, wherein said one or more relationships that are identified for said given interconnect comprise relationships between i) the test data value corresponding to the given interconnect, and ii) each of a number of test data values corresponding to one or more interconnects that are nearest the given interconnect.

5. The method of claim 1, wherein said one or more relationships that are identified for said given interconnect comprise relationships between i) the test data value corresponding to the given interconnect, and ii) each of a number of test data values corresponding to one or more interconnects that are within a defined window around the given interconnect.

6. The method of claim 1, wherein said relationships comprise differences between said test data values.

7. The method of claim 1, wherein defining said function for evaluating the interconnect of a DUT comprises training a neural network to recognize, for said given interconnect, patterns of acceptable relationships for said identified relationships.

8. The method of claim 7, wherein the neural network is trained by,
using said quantified relationships to generate a first pattern of acceptable relationships;
randomly generating a number of variants of said first pattern by introducing acceptable noise into said first pattern; and
teaching the neural network that each of said variants is a valid pattern of acceptable relationships.

9. The method of claim 1, wherein defining said function for evaluating the interconnect of a DUT comprises training a neural network to recognize, for said given interconnect, patterns of acceptable and unacceptable relationships for said identified relationships.

10. The method of claim 9, wherein the neural network is trained by,
using said quantified relationships to generate a first pattern of acceptable relationships;
randomly generating a number of variants of said first pattern by introducing acceptable noise into said first pattern;
randomly generating a number of variants of said first pattern by introducing unacceptable noise into said first pattern; and
teaching the neural network which of said variants are valid and invalid patterns of acceptable relationships.

11. The method of claim 10, wherein said acceptable and unacceptable noise is determined from at least one of: measurement uncertainty during acquisition of said test data values, estimations of noise during acquisition of said test data values, and manufacturing variations that are inherent in the DUT.

12. A method for evaluating device interconnect, comprising:
obtaining test data values corresponding to each of a number of interconnects of a device under test (DUT); and
for a given interconnect of the DUT, evaluating one or more relationships between two or more of the test data values to determine whether the given interconnect is acceptable.

13. The method of claim 12, wherein said test data values are obtained by iteratively,
stimulating at least one interconnect of the DUT; and
measuring an electrical characteristic between the stimulated interconnect(s) and a sensor.

14. The method of claim 13, wherein said measured electrical characteristic is capacitance.

15. The method of claim 12, wherein said one or more relationships that are evaluated for said given interconnect comprise relationships between i) the test data value corresponding to the given interconnect, and ii) each of a number of test data values corresponding to one or more interconnects that are nearest the given interconnect.

16. The method of claim 12, wherein said one or more relationships that are evaluated for said given interconnect comprise relationships between i) the test data value corresponding to the given interconnect, and ii) each of a number of test data values corresponding to one or more interconnects that are within a defined window around the given interconnect.

17. The method of claim 12, wherein said relationships comprise differences between said test data values.

18. The method of claim 17, wherein a plurality of relationships are evaluated for the given interconnect, and wherein said relationships are evaluated by submitting a pattern of said relationships to a neural network that has been trained to recognize patterns of acceptable relationships.

19. The method of claim 17, wherein a plurality of relationships are evaluated for the given interconnect, and wherein said relationships are evaluated by submitting a pattern of said relationships to a neural network that has been trained to recognize patterns of acceptable relationships corresponding to windows of adjacent interconnects of the DUT.

20. The method of claim 17, wherein a plurality of relationships are evaluated for the given interconnect, and wherein said relationships are evaluated by submitting a pattern of said relationships to a neural network that has been trained to recognize patterns of acceptable and unacceptable relationships.

21. The method of claim 17, wherein a plurality of relationships are evaluated for the given interconnect, and wherein said relationships are evaluated by submitting a pattern of said relationships to a neural network that has been trained to recognize patterns of acceptable and unacceptable relationships corresponding to windows of adjacent interconnects of the DUT.

22. The method of claim 12, wherein said determination of whether said given interconnect is acceptable comprises a pass/fail indication.

23. A vectorless test system, comprising:
computer readable media; and
program code stored on the computer readable media, said program code comprising:
rules identifying i) which of a plurality of test data values are related to a test data value of a given device interconnect, and ii) relationships between the test data values;
code to receive a plurality of known-good test data values for a device and, in accordance with said rules, quantify said relationships between test data values; and
code to define a function for evaluating the interconnect of a device under test (DUT) based on said identified and quantified relationships.

24. The test system of claim 23, wherein said test data values are capacitances.

25. The test system of claim 23, wherein said relationships comprise differences between said test data values.

26. The test system of claim 23, wherein said rules define relationships between i) the test data value corresponding to the given interconnect, and ii) the test data values corresponding to one or more interconnects that are nearest the given interconnect.

27. The test system of claim 23, wherein said rules define relationships between i) the test data value corresponding to the given interconnect, and ii) the test data values corresponding to one or more interconnects that are within a defined window around the given interconnect.

28. The test system of claim 23, further comprising code to generate said plurality of known-good test data values by,
normalizing a plurality of sets of known-good test data values; and
using a function approximator and the normalized sets of known-good test values to generate a single, normalized set of known-good test data values.

29. The test system of claim 23, wherein the function defined by the code programs a neural network to recognize, for said given interconnect, patterns of acceptable and unacceptable relationships for said identified relationships.

30. A vectorless test system, comprising:
a function approximator for generating a set of known-good test data values;
a relationship extractor for quantifying, for each interconnect of a device, a set of relationships between said known-good test data values;
a system for i) receiving said quantified relationships and acceptable and unacceptable noise limits, and ii) generating therefrom various patterns of acceptable and unacceptable relationships between test data values;
a neural network having a training mode, wherein said neural network receives said various patterns and learns how to identify acceptable and unacceptable relationships between test data values of a device under test (DUT).

31. The test system of claim 30, wherein the function approximator i) normalizes a plurality of sets of known-good test data values, and ii) consumes the normalized test data values to generate a single, normalized set of known-good test data values to said relationship extractor.

32. The test system of claim 30, further comprising a neural network to i) consume patterns of test data corresponding to interconnects of a DUT, and ii) output an indication of whether a consumed pattern is acceptable.

33. The test system of claim 32, wherein said neural networks are embodied in a single neural network that is switchable between a training mode and a test mode.

34. A vectorless test system, comprising:
computer readable media; and
program code stored on the computer readable media, said program code comprising code to i) evaluate one or more relationships between two or more test data values, each value of which corresponds to an interconnect of a device under test (DUT), and ii) determine from said evaluation(s) whether a given interconnect of the DUT is acceptable.

35. The test system of claim 34, wherein said test data values are capacitances.

36. The test system of claim 34, wherein said one or more relationships that are evaluated for said given interconnect comprise relationships between i) the test data value corresponding to the given interconnect, and ii) each of a number of test data values corresponding to one or more interconnects that are nearest the given interconnect.

37. The test system of claim 34, wherein said one or more relationships that are evaluated for said given interconnect comprise relationships between i) the test data value corresponding to the given interconnect, and ii) each of a number of test data values corresponding to one or more interconnects that are within a defined window around the given interconnect.

38. The test system of claim 34, wherein said relationships are differences between said test data values.

39. The test system of claim 34, wherein the code that performs said evaluations defines a neural network that receives said relationships and outputs a pass/fail indication for said given interconnect.
